(19) United States
(12) Patent Application Publication
(10) Pub. No.: US 2025/0348206 A1
(43) Pub. Date: Nov. 13, 2025

(54) INFORMATION PROCESSING APPARATUS, INFORMATION PROCESSING METHOD, AND NON-TRANSITORY RECORDING MEDIUM

(71) Applicant: Fumihiko MINAGAWA, Chiba (JP)

(72) Inventor: Fumihiko MINAGAWA, Chiba (JP)

(21) Appl. No.: 19/192,335

(22) Filed: Apr. 29, 2025

(30) Foreign Application Priority Data
May 7, 2024 (JP) 2024-075473

(51) Int. Cl. G06F 3/0488; G06F 3/0482; G06F 3/0484; G06T 7/70

(52) U.S. Cl. CPC G06F 3/0488; G06F 3/0482; G06F 3/0484; G06T 7/70; G06T 2200/24; G06T 2207/30196

(57) ABSTRACT

An information processing apparatus includes circuitry that: receives a captured image of a pointing object, from an image-capturing device that captures an image of the pointing object; detects a pointed position pointed to by the pointing object from the received captured image; determines whether the detected pointed position is in an area of a hardware key installed on an electronic device; and executes a function corresponding to a button of the hardware key, based on a determination that the pointed position is in the area of the hardware key.

### CROSS-REFERENCE TO RELATED APPLICATIONS

This patent application is based on and claims priority pursuant to 35 U.S.C. § 119(a) to Japanese Patent Application No. 2024-075473, filed on May 7, 2024, in the Japan Patent Office, the entire disclosure of which is hereby incorporated by reference herein.

### BACKGROUND

### Technical Field

The present disclosure relates to an information processing apparatus, an information processing method, and a non-transitory recording medium.

### Related Art

A pointing technology in the related art enables pointing and an operation in a screen but fails to implement an operation on a hardware key (hereinafter, referred to as a “hard key”) located outside the screen from a remote place. Methods for operating a hard key from a remote place include using an operation device such as a remote control. However, the necessity of fetching the operation device arises when the operation device is not located nearby.

### SUMMARY

The present disclosure described herein provides an information processing apparatus including circuitry. The circuitry receives a captured image of a pointing object, from an image-capturing device that captures an image of the pointing object. The circuitry detects a pointed position pointed to by the pointing object from the received captured image. The circuitry determines whether the detected pointed position is in an area of a hardware key installed on an electronic device. The circuitry executes a function corresponding to a button of the hardware key, based on a determination that the pointed position is in the area of the hardware key.

The present disclosure described herein provides an information processing method including receiving a captured image of a pointing object, from an image-capturing device that captures an image of the pointing object; detecting a pointed position pointed to by the pointing object from the received captured image; determining whether the detected pointed position is in an area of a hardware key installed on an electronic device; and executing a function corresponding to a button of the hardware key, based on a determination that the pointed position is in the area of the hardware key.

The present disclosure described herein provides a non-transitory recording medium storing a plurality of instructions which, when executed by one or more processors, causes the one or more processors to perform an information processing method. The information processing method includes receiving a captured image of a pointing object, from an image-capturing device that captures an image of the pointing object; detecting a pointed position pointed to by the pointing object from the received captured image; determining whether the detected pointed position is in an area of a hardware key installed on an electronic device; and executing a function corresponding to a button of the hardware key, based on a determination that the pointed position is in the area of the hardware key.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a general arrangement of an information processing system according to a first embodiment;

FIG. 2 is a diagram illustrating an example of a hardware configuration of an interactive whiteboard (IWB) according to the first embodiment;

FIG. 3 illustrates an example of a captured image obtained by a right image-capturing device;

FIG. 4 illustrates an example of a captured image obtained by a left image-capturing device;

FIG. 5 is a front view of a display of the IWB according to the first embodiment;

FIG. 6 is a diagram illustrating an example of a configuration of functional blocks of the IWB according to the first embodiment;

FIG. 7 is a diagram illustrating an example of an area definition table of the IWB according to the first embodiment;

FIG. 8 is a diagram illustrating an example of displaying a pointer at a pointed position in the IWB according to the first embodiment;

FIG. 9 is a diagram illustrating an example of displaying a software menu on the display when the pointed position is in a hard key area in the IWB according to the first embodiment;

FIG. 10 is a diagram illustrating another example of the area definition table of the IWB according to the first embodiment;

FIG. 11 is a diagram illustrating another example of displaying a software menu on the display when the pointed position is in the hard key area in the IWB according to the first embodiment;

FIG. 12 is a diagram illustrating still another example of the area definition table of the IWB according to the first embodiment;

FIG. 13 is a flowchart illustrating an example of the procedure of a software menu display operation in the IWB according to the first embodiment;

FIG. 14 is a flowchart illustrating an example of the procedure of a software menu execution operation in the IWB according to the first embodiment;

FIG. 15 is a flowchart illustrating an example of the procedure of a software menu hide operation in the IWB according to the first embodiment;

FIG. 16 is a diagram illustrating an example of a configuration of functional blocks of an IWB according to a second embodiment;

FIG. 17 is a flowchart illustrating an example of the procedure of a software menu display operation in the IWB according to the second embodiment;

FIG. 18 is a flowchart illustrating an example of the procedure of a software menu execution operation in the IWB according to the second embodiment;

FIG. 19 is a diagram illustrating an example of a hardware configuration of an IWB according to a third embodiment;

FIG. 20 is a diagram illustrating an example of a configuration of functional blocks of the IWB according to the third embodiment;

FIG. 21 is a flowchart illustrating an example of the procedure of a software menu display operation in the IWB according to the third embodiment;

FIG. 22 is a flowchart illustrating an example of the procedure of a software menu execution operation in the IWB according to the third embodiment; and

FIG. 23 is a flowchart illustrating an example of the procedure of a hard key function execution operation in an IWB according to a fourth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing apparatus, an information processing method, and a program according to embodiments of the present disclosure will be described in detail below with reference to the drawings. The present disclosure, however, is not limited to the following embodiments, and the constituent elements of the following embodiments include those that can be easily conceived by those skilled in the art, those being substantially the same ones, and those being within equivalent ranges. Various omissions, substitutions, changes, and combinations of the constituent elements can be made without departing from the gist of the following embodiments. Further, any one of the operations described below may be performed in various other ways, for example, in an order different from the one described below.

### First Embodiment

### General Arrangement of Information Processing System

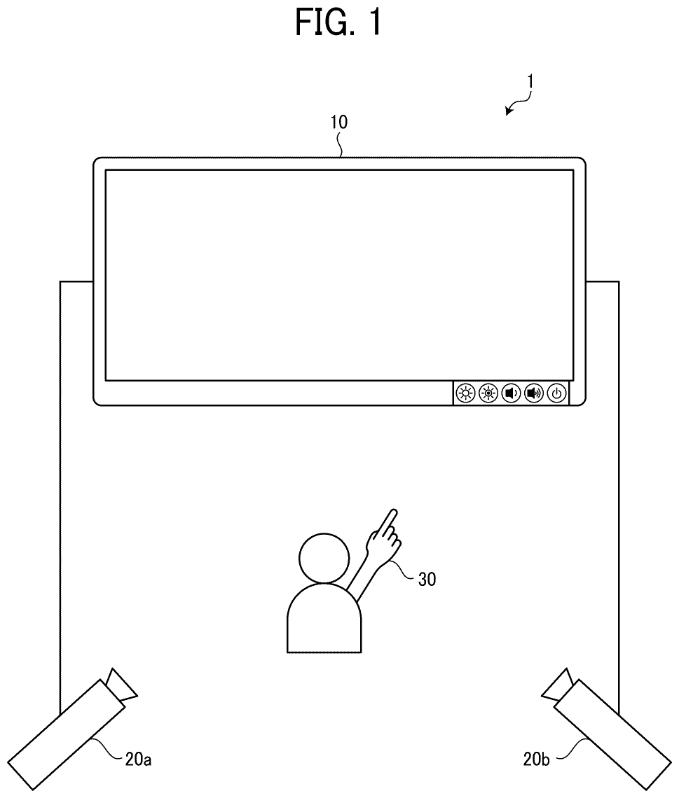

FIG. 1 is a diagram illustrating an example of a general arrangement of an information processing system 1 according to a first embodiment. The general arrangement of the information processing system 1 according to the present embodiment will be described with reference to FIG. 1.

As illustrated in FIG. 1, the information processing system 1 includes an interactive whiteboard (IWB) 10, a camera 20a, and a camera 20b. The IWB 10 is an electronic whiteboard.

The IWB 10 is an electronic device (an example of an information processing apparatus) that displays an image and allows a figure, text, or the like to be drawn on a display thereof with an electronic pen. Based on captured images received from the cameras 20a and 20b, the IWB 10 detects a position (pointed position) pointed to by a pointing object 30 such as a user's hand or a pointer stick.

In the following description, the term “pointing” is used to refer to “indicating”, which means to direct attention to a specific object, for example, through various user operations including gesturing. Examples of user operations include clicking, hovering, selecting, tapping, swiping, and marking.

The camera 20a is an image-capturing device that is installed on the left side of a user in a direction from the user toward the IWB 10 and is connected to the IWB 10. The camera 20a captures an image at an angle of view including the display of the IWB 10 and the pointing object 30, and transmits the captured image to the IWB 10.

The camera 20b is an image-capturing device that is installed on the right side of the user in the direction from the user toward the IWB 10 and is connected to the IWB 10. The camera 20b captures an image at an angle of view including the display of the IWB 10 and the pointing object 30, and transmits the captured image to the IWB 10.

### Hardware Configuration of IWB

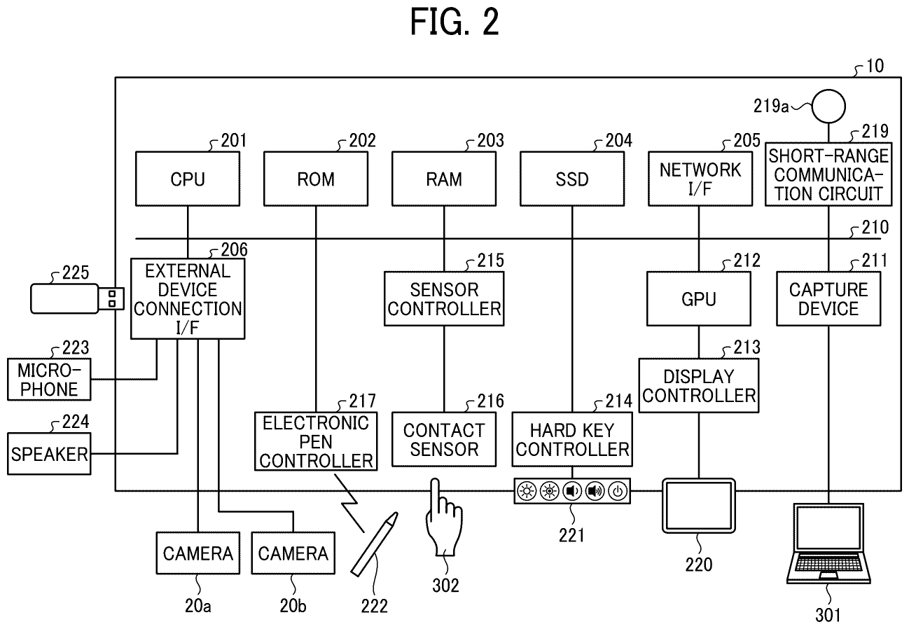

FIG. 2 is a diagram illustrating an example of a hardware configuration of the IWB 10 according to the first embodiment. The hardware configuration of the IWB 10 according to the present embodiment will be described with reference to FIG. 2.

As illustrated in FIG. 2, the IWB 10 according to the present embodiment includes a central processing unit (CPU) 201, a read-only memory (ROM) 202, a random access memory (RAM) 203, a solid state drive (SSD) 204, a network interface (I/F) 205, an external device connection I/F 206, a capture device 211, a graphics processing unit (GPU) 212, a display controller 213, a hard key controller 214, a sensor controller 215, a contact sensor 216, an electronic pen controller 217, a short-range communication circuit 219, a display 220, and a hard key 221.

The CPU 201 is an arithmetic device that controls operations of the entire IWB 10. The ROM 202 is a nonvolatile storage device that stores a program for booting the CPU 201, such as an initial program loader (IPL). The RAM 203 is a volatile storage device that serves as a work area for the CPU 201.

The SSD 204 is an auxiliary storage device that stores various kinds of data such as a program for the IWB 10.

The network I/F 205 is an interface circuit for performing data communication via a network. For example, the network I/F 205 is an interface circuit that enables communication conforming to Ethernet®, Transmission Control Protocol/Internet Protocol (TCP/IP), or the like.

The external device connection I/F 206 is an interface circuit that connects various external devices to the IWB 10. Examples of the external devices in this case include a Universal Serial Bus (USB) memory 225 and externally attached devices such as a microphone 223, a speaker 224, the camera 20a, and the camera 20b.

The capture device 211 is a device circuit that causes a display of an external personal computer (PC) 301 to display video information as a still image or a moving image.

The GPU 212 is an arithmetic device that exclusively performs image processing. The display controller 213 is a controller that controls and manages displaying of a screen to output an image having undergone image processing performed by the GPU 212 to the display 220 or the like.

The hard key controller 214 is a controller that detects a user operation on the hard key 221 including one or more buttons installed on a housing of the IWB 10. In response to an operation on the hard key 221, the hard key controller 214 makes a request for processing to a software program and a request to control the display 220 to the display controller 213.

The sensor controller 215 is a controller that controls processing of the contact sensor 216. The contact sensor 216 is a sensor that detects a contact of an electronic pen 222 or a finger 302 of a user on the display 220. Specifically, the contact sensor 216 detects a touch input on the display 220 and the coordinates of the touch input using the infrared blocking system. In this method of detecting a touch input on the display 220 and the coordinates of the touch input, the display 220 is provided with two light emitting/receiving devices disposed on respective upper side ends of the display 220 and with a reflector member surrounding the display 220. The light emitting/receiving devices emit a plurality of infrared rays in parallel to a surface of the display 220. The plurality of infrared rays are reflected by the reflector member. Light receiving elements of the light emitting/receiving devices receive light returning along the same optical path as the optical path of the emitted light. The contact sensor 216 outputs an ID of the infrared ray that is blocked by an object after being emitted from the two light emitting/receiving devices, to the sensor controller 215. Based on the ID of the infrared ray, the sensor controller 215 identifies coordinates of the position that is the contact position of the object.

The electronic pen controller 217 is a controller that communicates with the electronic pen 222 to detect a touch of the tip or bottom of the electronic pen 222 onto the display 220.

The short-range communication circuit 219 is a communication circuit in compliance with Near Field Communication (NFC), Bluetooth®, or the like. The short-range communication circuit 219 is connected to an antenna 219a for wireless communication.

The display 220 is a display device, such as a liquid crystal display or an organic electro-luminescence (EL) display, that displays various images.

The hard key 221 is a hardware key that includes a power button, a sleep button, and buttons for executing various functions such as display adjustment. Note that the hard key 221 is not limited to a hardware key already installed on the IWB 10, and may be an external hardware key connectable to the hard key controller 214.

The IWB 10 further includes a bus 210. The bus 210 is an address bus or a data bus that electrically connects the constituent elements such as the CPU 201 illustrated in FIG. 2 to one another.

The contact sensor 216 is not limited to a sensor of the infrared blocking system, and may be any of sensors of various types such as a capacitive touch panel that detects a change in capacitance to identify the contact position, a resistive film touch panel that detects a change in voltage across two opposed resistive films to identify the contact position, and an electromagnetic induction touch panel that detects electromagnetic induction caused by a contact of an object onto the display 220 to identify the contact position. The electronic pen controller 217 may detect a touch of a part of the electronic pen 222 held by a user or another part of the electronic pen 222 as well as a touch of the tip or bottom of the electronic pen 222.

### Calculation of Transformation Matrix

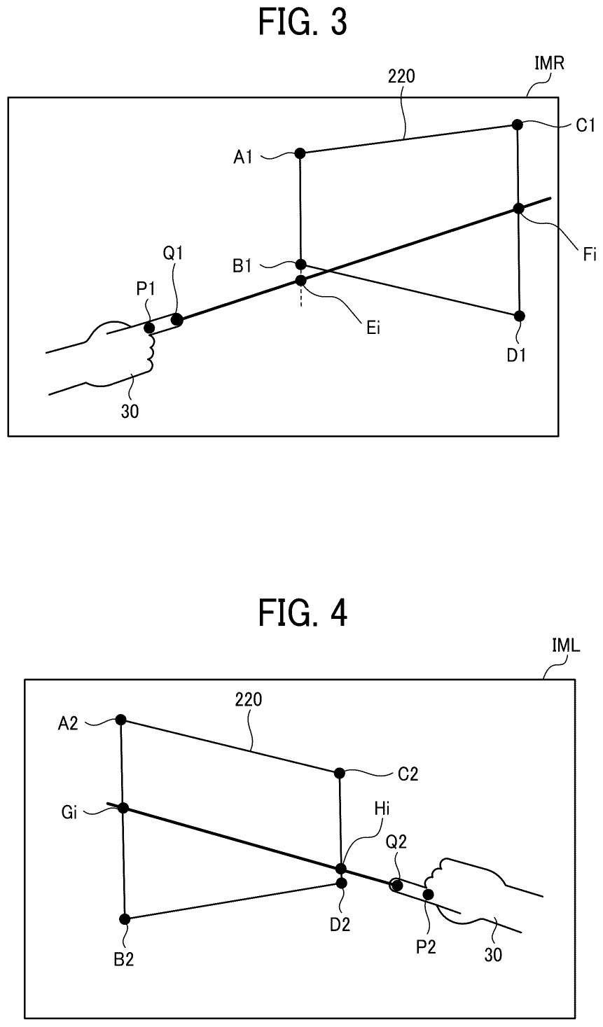

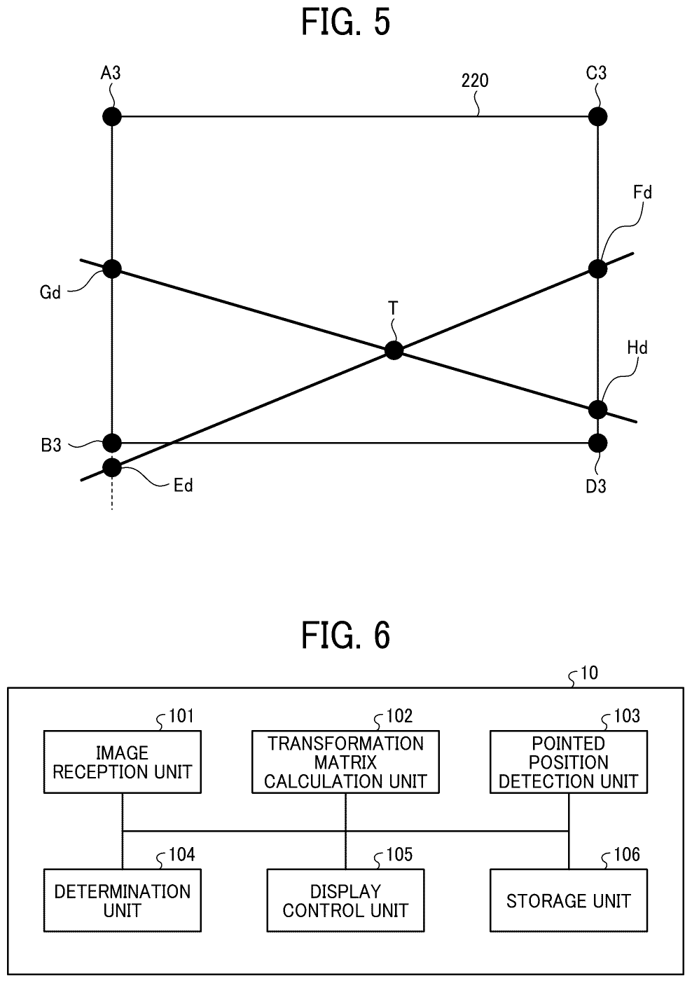

FIG. 3 illustrates an example of a captured image obtained by the right image-capturing device 20b. FIG. 4 illustrates an example of a captured image obtained by the left image-capturing device 20a. FIG. 5 is a front view of the display 220 of the IWB 10 according to the first embodiment. With reference to FIGS. 3 to 5, the description will be given of a method for detecting a pointed position pointed to by the pointing object 30 using two cameras (i.e., the cameras 20a and 20b) in the information processing system 1 according to the present embodiment.

FIG. 3 illustrates a captured image IMR (hereinafter, may be referred to as a right captured image) obtained by the right camera 20b. FIG. 4 illustrates a captured image IML (hereinafter, may be referred to as a left captured image) obtained by the left camera 20a.

The IWB 10 receives the right captured image from the camera 20b, extracts an object such as a hand from the right captured image, and compares shape data and color data of this object with pre-stored shape data and color data of hands each with one pointing finger to determine that the object is a hand with a pointing finger. This determination is made using machine learning based on many shape data items and color data items of hands each with one pointing finger.

The IWB 10 identifies a base (a point P1 illustrated in FIG. 3) and a tip (a point Q1 illustrated in FIG. 3) of a finger. The IWB 10 compares shape data of an object extracted from the right captured image with pre-stored shape data of the display 220 to determine that the object is the display 220. This determination is made using machine learning based on many shape data items of the display 220.

The right captured image (captured image IMR) illustrated in FIG. 3 includes points

A1, B1, C1, and D1 that represent an upper left corner, a lower left corner, an upper right corner, and a lower right corner of the display 220, respectively. In the right captured image illustrated in FIG. 3, an extended line of a line segment P1Q1 intersects with an extended line of a line segment A1B1 at a point Ei. The extended line of the line segment P1Q1 also intersects with a line segment CID1 at a point Fi.

As in the above case, the IWB 10 receives the left captured image from the camera 20a, determines a hand with one pointing finger from the left captured image, and identifies a base (a point P2 illustrated in FIG. 4) and a tip (a point Q2 illustrated in FIG. 4) of this finger. As in the above case, the IWB 10 then determines the display 220 from the left captured image.

The left captured image (captured image IML) illustrated in FIG. 4 includes points A2, B2, C2, and D2 that represent the upper left corner, the lower left corner, the upper right corner, and the lower right corner of the display 220, respectively. In the left captured image illustrated in FIG. 4, an extended line of a line segment P2Q2 intersects with a line segment A2B2 at a point Gi. The extended line of the line segment P2Q2 also intersects with a line segment C2D2 at a point Hi.

FIG. 5 is a front view of the display 220 of the IWB 10. A point T, on the display 220, pointed to by the finger corresponds to an intersection between a line linking to each other the point Ei and the point Fi in the right captured image obtained by the right camera 20b and a line linking to each other the point Gi and the point Hi in the left captured image obtained by the left camera 20a. The coordinates in the captured image are based on a pixel position of the captured image. Thus, displaying a pointer or the like at the point (i.e., the pointed position) pointed to by the finger involves transformation of the coordinates based on the pixel position of the captured image into coordinates based on the display pixel position on the display 220.

FIG. 5 illustrate points A3, B3, C3, and D3 which respectively represent the upper left corner, the lower left corner, the upper right corner, and the lower right corner of the display 220. Points Ed and Fd are at coordinates that are based on the display pixel position of the display 220. The coordinates of the points Ed and Fd are obtained by transforming the coordinates of the points Ei and Fi in the right captured image from the coordinates based on the pixel position of the right captured image, using a transformation matrix TR (described later) for coordinates transformation. Points Gd and Hd are at coordinates that are based on the display pixel position of the display 220. The coordinates of the points Gd and Hd are obtained by transforming the coordinates of the points Gi and Hi in the left captured image from the coordinates based on the pixel positions in the left captured image, using a transformation matrix TL (described later) for coordinates transformation.

The transformation matrices TR and TL are determined by Expressions below. Let A1 (a1x, a1y), B1 (b1x, b1y), C1 (c1x, c1y), and D1 (d1x, d1y) respectively denote the coordinates of the upper left corner, the lower left corner, the upper right corner, and the lower right corner of the display 220 based on the pixel position of the right captured image. Let A3 (a3x, a3y), B3 (b3x, b3y), C3 (c3x, c3y), and D3 (d3x, d3y) respectively denote the coordinates of the upper left corner, the lower left corner, the upper right corner, and the lower right corner of the display 220 based on the display pixel position of the display 220. Then, eight simultaneous equations represented by Expression (1) below are obtained.

$$\begin{matrix}a 3 x = ( R 11 \cdot a 1 x + R 12 \cdot a 1 y + R 13 ) / ( R 31 \cdot a 1 x + R 32 \cdot a 1 y + 1 ) \\ a 3 y = ( R 21 \cdot a 1 x + R 22 \cdot a 1 y + R 23 ) / ( R 31 \cdot a 1 x + R 32 \cdot a 1 y + 1 ) \\ b 3 x = ( R 11 \cdot b 1 x + R 12 \cdot b 1 y + R 13 ) / ( R 31 \cdot b 1 x + R 32 \cdot b 1 y + 1 ) \\ b 3 y = ( R 21 \cdot b 1 x + R 22 \cdot b 1 y + R 23 ) / ( R 31 \cdot b 1 x + R 32 \cdot b 1 y + 1 ) \\ c 3 x = ( R 11 \cdot c 1 x + R 12 \cdot c 1 y + R 13 ) / ( R 31 \cdot c 1 x + R 32 \cdot c 1 y + 1 ) \\ c 3 y = ( R 21 \cdot c 1 x + R 22 \cdot c 1 y + R 23 ) / ( R 31 \cdot c 1 x + R 32 \cdot c 1 y + 1 ) \\ d 3 x = ( R 11 \cdot d 1 x + R 12 \cdot d 1 y + R 13 ) / ( R 31 \cdot d 1 x + R 32 \cdot d 1 y + 1 ) \\ d 3 y = ( R 21 \cdot d 1 x + R 22 \cdot d 1 y + R 23 ) / ( R 31 \cdot d 1 x + R 32 \cdot d 1 y + 1 )\end{matrix} \} \qquad ( 1 )$$

From the simultaneous equations represented by Expression (1), the transformation matrix TR for transforming the coordinates in the right captured image into the coordinates based on the display pixel position of the display 220 is calculated as represented by Expression (2) below.

$$TR = ( \begin{matrix}R 11 & R 12 & R 13 \\ R 21 & R 22 & R 23 \\ R 31 & R 32 & R 33\end{matrix} ) \qquad ( 2 )$$

Let A2 (a2x, a2y), B2 (b2x, b2y), C2 (c2x, c2y), and D2 (d2x, d2y) respectively denote the coordinates of the upper left corner, the lower left corner, the upper right corner, and the lower right corner of the display 220 based on the pixel position of the left captured image. Let A3 (a3x, a3y), B3 (b3x, b3y), C3 (c3x, c3y), and D3 (d3x, d3y) respectively denote the coordinates of the upper left corner, the lower left corner, the upper right corner, and the lower right corner of the display 220 based on the display pixel position of the display 220. Then, eight simultaneous equations represented by Expression (3) below are obtained.

$$\begin{matrix}a 3 x = ( L 11 \cdot a 2 x + L 12 \cdot a 2 y + L 13 ) / ( L 31 \cdot a 2 x + L 32 \cdot a 2 y + 1 ) \\ a 3 y = ( L 21 \cdot a 2 x + L 22 \cdot a 2 y + L 23 ) / ( L 31 \cdot a 2 x + L 32 \cdot a 2 y + 1 ) \\ b 3 x = ( L 11 \cdot b 2 x + L 12 \cdot b 2 y + L 13 ) / ( L 31 \cdot b 2 x + L 32 \cdot b 2 y + 1 ) \\ b 3 y = ( L 21 \cdot b 2 x + L 22 \cdot b 2 y + L 23 ) / ( L 31 \cdot b 2 x + L 32 \cdot b 2 y + 1 ) \\ c 3 x = ( L 11 \cdot c 2 x + L 12 \cdot c 2 y + L 13 ) / ( L 31 \cdot c 2 x + L 32 \cdot c 2 y + 1 ) \\ c 3 y = ( L 21 \cdot c 2 x + L 22 \cdot c 2 y + L 23 ) / ( L 31 \cdot c 2 x + L 32 \cdot c 2 y + 1 ) \\ d 3 x = ( L 11 \cdot d 2 x + L 12 \cdot d 2 y + L 13 ) / ( L 31 \cdot d 2 x + L 32 \cdot d 2 y + 1 ) \\ d 3 y = ( L 21 \cdot d 2 x + L 22 \cdot d 2 y + L 23 ) / ( L 31 \cdot d 2 x + L 32 \cdot d 2 y + 1 )\end{matrix} \} \qquad ( 3 )$$

From the simultaneous equations represented by Expression (3), the transformation matrix TL for transforming the coordinates in the left captured image into the coordinates based on the display pixel position of the display 220 is calculated as represented by Expression (4) below.

$$TL = ( \begin{matrix}L 11 & L 12 & L 13 \\ L 21 & L 22 & L 23 \\ L 31 & L 32 & L 33\end{matrix} ) \qquad ( 4 )$$

By using the transformation matrix TR represented by Expression (2) above and Expressions (5) and (6) below, the point Ei (eix, eiy) in the right captured image is transformed into the point Ed (edx, edy) represented by the display pixel coordinates on the display 220.

$$( \begin{matrix}edtx \\ edty \\ edta\end{matrix} ) = ( \begin{matrix}R 11 & R 12 & R 13 \\ R 21 & R 22 & R 23 \\ R 31 & R 32 & R 33\end{matrix} ) ( \begin{matrix}eix \\ eiy \\ 1\end{matrix} ) \qquad ( 5 )$$

$$\begin{matrix}edx = edtx / edta \\ edy = edty / edta\end{matrix} \} \qquad ( 6 )$$

By using the transformation matrix TR represented by Expression (2) above and Expressions (7) and (8) below, the point Fi (fix, fiy) in the right captured image is transformed into the point Fd (fdx, fdy) represented by the display pixel coordinates on the display 220.

$$( \begin{matrix}fdtx \\ fdty \\ fdta\end{matrix} ) = ( \begin{matrix}R 11 & R 12 & R 13 \\ R 21 & R 22 & R 23 \\ R 31 & R 32 & R 33\end{matrix} ) ( \begin{matrix}fix \\ fiy \\ 1\end{matrix} ) \qquad ( 7 )$$

$$\begin{matrix}fdx = fdtx / fdta \\ fdy = fdty / fdta\end{matrix} \} \qquad ( 8 )$$

By using the transformation matrix TL represented by Expression (4) above and Expressions (9) and (10) below, the point Gi (gix, giy) in the left captured image is transformed into the point Gd (gdx, gdy) represented by the display pixel coordinates on the display 220.

$$( \begin{matrix}gdtx \\ gdty \\ gdta\end{matrix} ) = ( \begin{matrix}L 11 & L 12 & L 13 \\ L 21 & L 22 & L 23 \\ L 31 & L 32 & L 33\end{matrix} ) ( \begin{matrix}gix \\ giy \\ 1\end{matrix} ) \qquad ( 9 )$$

$$\begin{matrix}gdx = gdtx / gdta \\ gdy = gdty / gdta\end{matrix} \} \qquad ( 10 )$$

By using the transformation matrix TL represented by Expression (4) above and Expressions (11) and (12) below, the point Hi (hix, hiy) in the left captured image is transformed into the point Hd (hdx, hdy) represented by the display pixel coordinates on the display 220.

$$( \begin{matrix}hdtx \\ hdty \\ hdta\end{matrix} ) = ( \begin{matrix}L 11 & L 12 & L 13 \\ L 21 & L 22 & L 23 \\ L 31 & L 32 & L 33\end{matrix} ) ( \begin{matrix}hix \\ hiy \\ 1\end{matrix} ) \qquad ( 11 )$$

$$\begin{matrix}hdx = hdtx / hdta \\ hdy = hdty / hdta\end{matrix} \} \qquad ( 12 )$$

The coordinates at which the point T pointed to by the finger is displayed on the display 220 is the intersection between a line segment EdFd and a line segment GdHd. Thus, the IWB 10 calculates a linear equation of the line segment EdFd and a linear equation of the line segment GdHd, and can calculate the coordinates where the point T is displayed from simultaneous equations of these linear equations. The transformation matrices TR and TL respectively represented by Expressions (2) and (4) above are calculated just once as long as the installed positions of the cameras 20a and 20b are kept unchanged. The IWB 10 may store the transformation matrices TR and TL in the RAM 203 or the SSD 204.

### Configuration and Operation of Functional Blocks of IWB

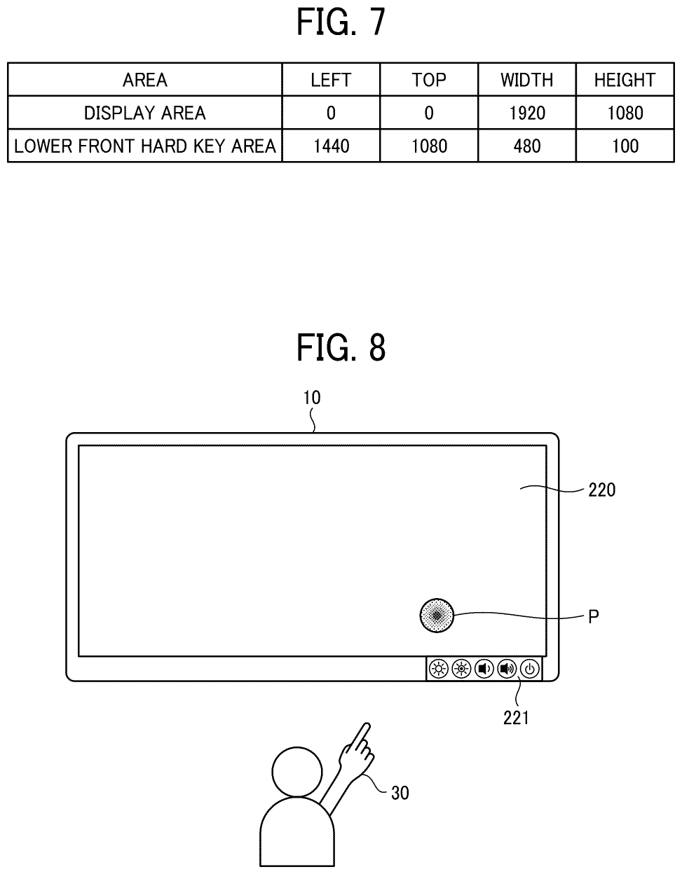

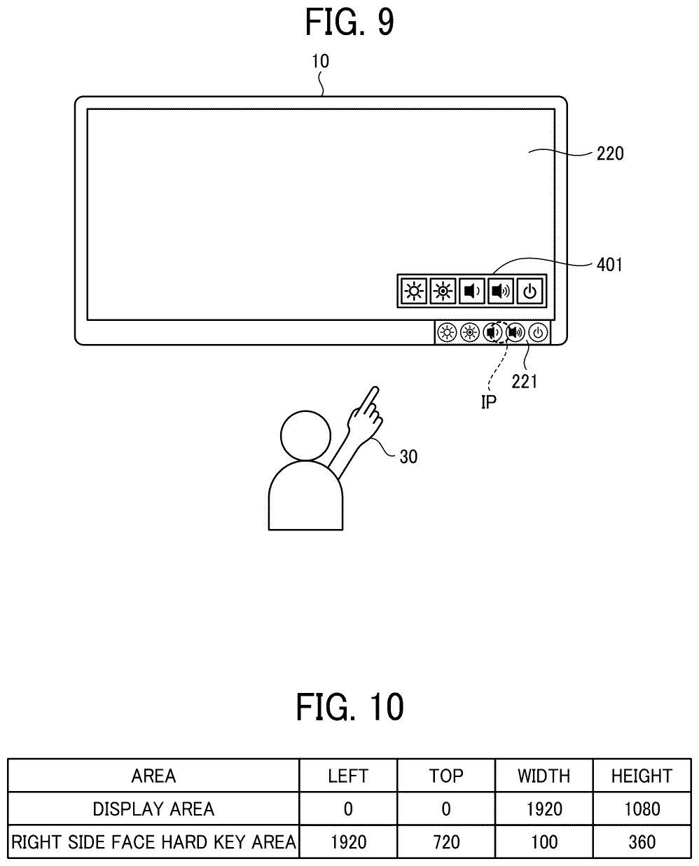

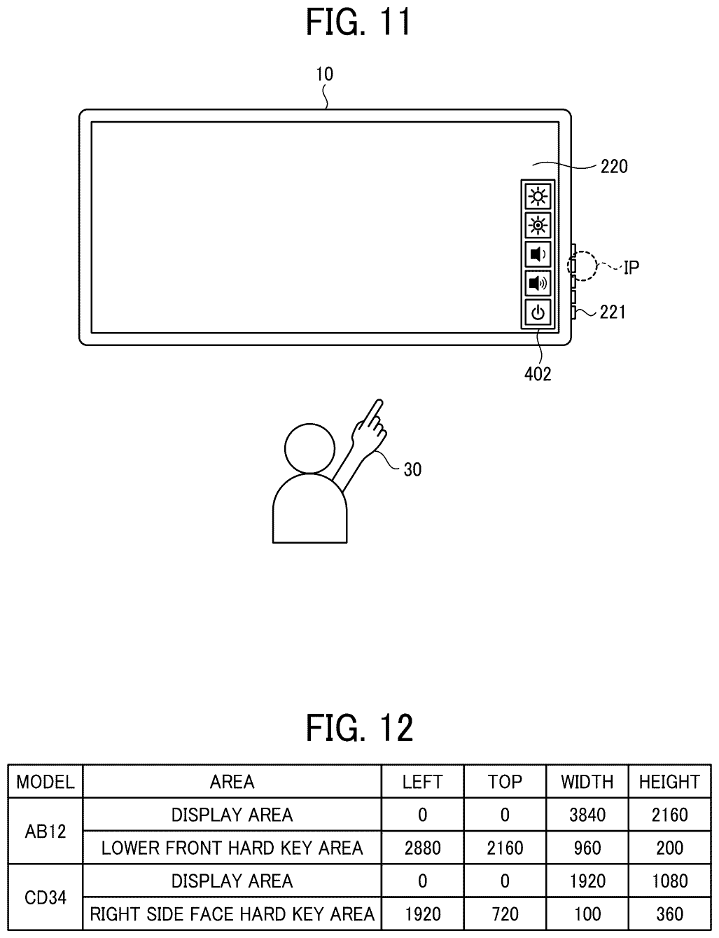

FIG. 6 is a diagram illustrating an example of a configuration of functional blocks of the IWB according to the first embodiment. FIG. 7 is a diagram illustrating an example of an area definition table of the IWB according to the first embodiment of the present disclosure. FIG. 8 is a diagram illustrating an example of displaying a pointer at a pointed position in the IWB according to the first embodiment. FIG. 9 is a diagram illustrating an example of displaying a software menu on the display when the pointed position is in a hard key area in the IWB according to the first embodiment. FIG. 10 is a diagram illustrating another example of the area definition table of the IWB according to the first embodiment. FIG. 11 is a diagram illustrating another example of displaying a software menu on the display when the pointed position is in the hard key area in the IWB according to the first embodiment. FIG. 12 is a diagram illustrating another example of the area definition table of the IWB according to the first embodiment. With reference to FIGS. 6 to 12, the configuration and the operation of functional blocks of the IWB 10 according to the present embodiment will be described.

As illustrated in FIG. 6, the IWB 10 includes an image reception unit 101 (reception unit), a transformation matrix calculation unit 102, a pointed position detection unit 103 (detection unit), a determination unit 104 (first determination unit), a display control unit 105, and a storage unit 106.

The image reception unit 101 is a functional unit that receives, via the external device connection I/F 206, captured images (i.e., the left captured image and the right captured image) obtained respectively by the cameras 20a and 20b.

The transformation matrix calculation unit 102 is a functional unit that calculates the transformation matrices TR and TL described above. Specifically, first, the transformation matrix calculation unit 102 uses the above-described method to extract an object representing the display 220 from the right captured image received by the image reception unit 101, and identify the coordinates of the above-described points A1, B1, C1, and D1 based on the object. The transformation matrix calculation unit 102 calculates the transformation matrix TR using Expressions (1) and (2) above. Likewise, the transformation matrix calculation unit 102 uses the above-described method to extract an object representing the display 220 from the left captured image received by the image reception unit 101, and identify the coordinates of the above-described points A2, B2, C2, and D2 based on the object. The transformation matrix calculation unit 102 calculates the transformation matrix TL using Expressions (3) and (4) above. The transformation matrix calculation unit 102 stores the calculated transformation matrices TR and TL in the storage unit 106.

Note that the transformation matrix calculation unit 102 may calculate the transformation matrices TR and TL just once as long as the installed positions of the cameras 20a and 20b and the IWB 10 (i.e., the display 220) are kept unchanged. In the subsequent processing, the transformation matrices TR and TL stored in the storage unit 106 may be referred to and used.

The pointed position detection unit 103 is a functional unit that detects the pointed position pointed to by the pointing object 30, by using the right captured image and the left captured image received by the image reception unit 101. Specifically, first, the pointed position detection unit 103 uses the above-described method to extract the object representing the display 220 and the object representing the pointing object 30 from the right captured image received by the image reception unit 101, and identify the coordinates of the points Ei and Fi. The pointed position detection unit 103 uses Expressions (5) and (6) and the transformation matrix TR stored in the storage unit 106 to calculate the coordinates of the display position of the point Ed on the display 220 from the coordinates of the point Ei. The pointed position detection unit 103 uses Expressions (7) and (8) and the transformation matrix TR to calculate the coordinates of the display position of the point Fd on the display 220 from the coordinates of the point Fi. The pointed position detection unit 103 also uses the above-described method to extract the object representing the display 220 and the object representing the pointing object 30 from the left captured image received by the image reception unit 101, and identify the coordinates of the points Gi and Hi. The pointed position detection unit 103 uses Expressions (9) and (10) and the transformation matrix TL stored in the storage unit 106 to calculate the coordinates of the display position of the point Gd on the display 220 from the coordinates of the point Gi. The pointed position detection unit 103 uses Expressions (11) and (12) and the transformation matrix TL to calculate the coordinates of the display position of the point Hd on the display 220 from the coordinates of the point Hi. Note that the coordinates of the display position refer to a concept including not only coordinates in the display area of the display 220 but also coordinates in an area outside the display area in the same plane as the display area. The pointed position detection unit 103 identifies the coordinates of the display position of the point T, which is the intersection between the line segment EdFd and the line segment GdHd, and detects the identified coordinates as the pointed position pointed to by the pointing object 30.

The determination unit 104 is a functional unit that determines whether the pointed position pointed to by the pointing object 30 and detected by the pointed position detection unit 103 is in a predetermined area.

For example, the area definition table illustrated in FIG. 7 associates an X-coordinate (Left) of the left end of each area, a Y-coordinate (Top) of the upper end of the area, a width (Width) of the area in an X-direction, and a height (Height) of the area in a Y-direction with one another, and defines a range of each area. The area definition table is stored in the storage unit 106. In the example illustrated in FIG. 7, the area definition table defines a display area of the display 220 illustrated in FIG. 8 as a “display area” and an area of the hard key 221 at the lower part of the display 220 as a “lower front hard key area”. As illustrated in FIG. 7, the display area is an area having the origin that is a point at the left end and the top end, a width of 1920 pixels, and a height of 1080 pixels. As illustrated in FIG. 7, the lower front hard key area has the left end at the coordinate of 1440 pixels and the top end at the coordinate of 1080 pixels. Thus, the lower front hard key area is an area that is outside the display area of the display 220 (i.e., the above-described display area) and has a width of 480 pixels and a height of 100 pixels.

With reference to the area definition table stored in the storage unit 106, the determination unit 104 determines whether the pointed position pointed to by the pointing object 30 and detected by the pointed position detection unit 103 is in each of the areas defined by the area definition table. For example, the determination unit 104 determines that the pointed position detected by the pointed position detection unit 103 is in the area of the hard key 221 when the horizontal-direction coordinate of the pointed position is in a range of 1440 to 1920 pixels and the vertical-direction coordinate of the pointed position is in a range of 1080 to 1180 pixels.

The display control unit 105 is a functional unit that controls a display operation of the display 220. For example, when the determination unit 104 determines that the pointed position is in the display area of the display 220, the display control unit 105 causes a pointer P to be displayed at the pointed position on the display 220 as illustrated in FIG. 8 to make the pointed position visible. In this manner, the pointed position is displayed as the pointer P on the display 220. This allows the user to visually recognize the pointed position and adjust the pointed position. When the determination unit 104 determines that the pointed position is in the area of the hard key 221 at the lower part of the display 220 (“the lower front hard key area” of the area definition table), the display control unit 105 causes a software menu 401 to be displayed in the display area of the display 220 near the hard key 221 as illustrated in FIG. 9. The software menu 401 is, for example, a menu including a software key (buttons) corresponding to the buttons of the hard key 221 as illustrated in FIG. 9. As described above, for example, the user points to a position in the display area of the display 220, and then moves the pointer P indicating the pointed position and displayed as illustrated in FIG. 8 to a position in the area of the hard key 221 outside the display area of the display 220. This allows the user to easily point to a position in the area of the hard key 221 outside the display area of the display 220.

Note that the software menu 401 displayed on the display 220 is not limited to a menu including buttons corresponding to all the buttons included in the hard key 221, and may be a menu including a button corresponding to at least one of the buttons including the hard key 221.

The storage unit 106 is a functional unit that stores the transformation matrices TR and TL calculated by the transformation matrix calculation unit 102, the area definition table illustrated in FIG. 7, and so on. The storage unit 106 is implemented by the RAM 203 or the SSD 204 illustrated in FIG. 2.

The image reception unit 101, the transformation matrix calculation unit 102, the pointed position detection unit 103, the determination unit 104, and the display control unit 105 described above are implemented by the CPU 201 illustrated in FIG. 2 executing a program. Note that at least part of the image reception unit 101, the transformation matrix calculation unit 102, the pointed position detection unit 103, the determination unit 104, and the display control unit 105 may be implemented by hardware circuitry such as a field-programmable gate array (FPGA) or an application-specific integrated circuit (ASIC).

The hard key 221 is not limited to that installed at a lower part of the display 220, and may be installed, for example, on a side face of the display 220 as illustrated in FIG. 11 or at an upper part of the display 220. FIG. 10 presents an example of the area definition table in the case where the hard key 221 is installed on the side face of the display 220 as illustrated in FIG. 11. In this case, as illustrated in FIG. 10, the area of the hard key 221 (right side face hard key area) has the left end at the coordinate of 1920 pixels and the upper end at the coordinate of 720 pixels. Thus, the right side face hard key area is an area that is outside the display area of the display 220 (display area) and has a width of 100 pixels and a height of 360 pixels. For example, the determination unit 104 determines that the pointed position detected by the pointed position detection unit 103 is in the area of the hard key 221 when the horizontal-direction coordinate of the pointed position is in a range of 1920 to 2020 pixels and the vertical-direction coordinate of the pointed position is in a range of 720 to 1080 pixels. When the determination unit 104 determines that the pointed position is in the area of the hard key 221 on the side face of the display 220 (“the right side face hard key area” of the area definition table), the display control unit 105 causes a software menu 402 to be displayed in the display area of the display 220 near the hard key 221 as illustrated in FIG. 11.

The area definition table illustrated in FIGS. 7 and 10 each correspond to the IWB 10 of a specific model. When the installed position of the hard key varies for each of a plurality of models, an area definition table illustrated in FIG. 12 in which a model is associated with the individual areas may be used. This allows the same software to be applied to different models.

All of the image reception unit 101, the transformation matrix calculation unit 102, the pointed position detection unit 103, the determination unit 104, the display control unit 105, and the storage unit 106 are implemented in the IWB 10. However, the configuration is not limited to this one, and at least one of these units may be implemented in another information processing apparatus. That is, the other information processing apparatus functions to implement a process that allows functions of a hardware key (such as the hard key 221) of an electronic device such as the IWB 10 to be operated from a remote place.

The functional units of the IWB 10 illustrated in FIG. 6 are a conceptual illustration of the functions, and are not limited to such a configuration. That is, the functional units of the IWB 10 are not necessarily configured as software modules that are explicit as the blocks illustrated in FIG. 6. The functions of the functional units may be implemented as a whole as a result of execution of the program in the IWB 10. For example, a plurality of functional units illustrated as the independent functional units in the IWB 10 in FIG. 6 may be configured as a single functional unit. Conversely, the function of one of the functional units of the IWB 10 illustrated in FIG. 6 may be divided and configured as a plurality of functional units.

### Procedure of Software Menu Display Operation in IWB

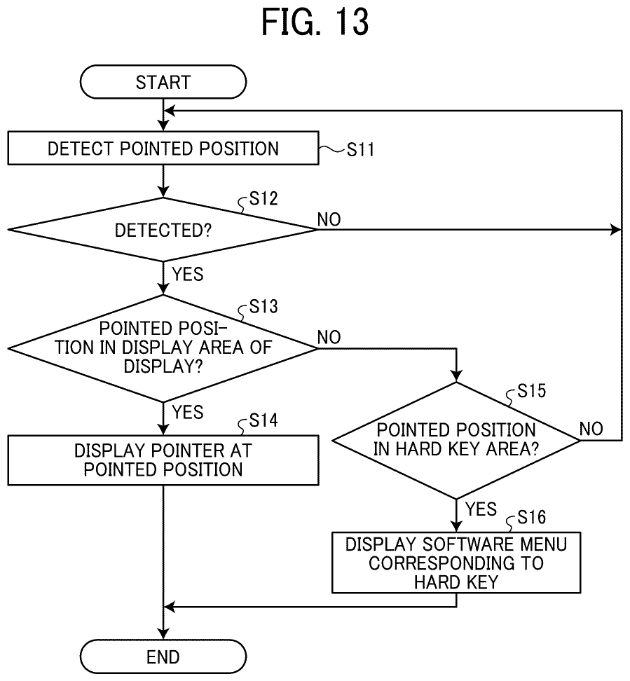

FIG. 13 is a flowchart illustrating an example of the procedure of a software menu display operation in the IWB according to the first embodiment. With reference to FIG. 13, the procedure of the software menu display operation in the IWB 10 according to the present embodiment will be described.

In step S11, the image reception unit 101 of the IWB 10 receives, via the external device connection I/F 206, captured images (i.e., the left captured image and the right captured image) obtained by the cameras 20a and 20b. The pointed position detection unit 103 of the IWB 10 detects the pointed position pointed to by the pointing object 30 such as a user's finger, by using the right captured image and the left captured image received by the image reception unit 101. The process proceeds to step S12.

In step S12, when the pointed position is detected by the pointed position detection unit 103 (step S12: Yes), the process proceeds to step S13. When the pointed position is not detected (step S12: No), the process returns to step S11.

In step S13, with reference to the area definition table stored in the storage unit 106, the determination unit 104 of the IWB 10 determines whether the pointed position pointed to by the pointing object 30 and detected by the pointed position detection unit 103 is in the display area of the display 220 defined by the area definition table. When the pointed position is in the display area of the display 220 (step S13: Yes), the process proceeds to step S14. When the pointed position is outside the display area (step S13: No), the process proceeds to step S15.

In step S14, the display control unit 105 of the IWB 10 causes the pointer P to be displayed at the pointed position on the display 220 to make the pointed position visible. The software menu display operation then ends.

In step S15, with reference to the area definition table stored in the storage unit 106, the determination unit 104 determines whether the pointed position pointed to by the pointing object 30 and detected by the pointed position detection unit 103 is in the area of the hard key 221 defined by the area definition table. When the pointed position is in the area of the hard key 221 (step S15: Yes), the process proceeds to step S16. When the pointed position is outside the area of the hard key 221 (step S15: No), the process returns to step S11.

In step S16, the display control unit 105 causes the software menu 401 to be displayed in the display area of the display 220 near the hard key 221. The software menu display operation then ends.

The operation of steps S11 to S16 described above is repeatedly performed. In such a procedure, when the user points to the area of the hard key 221, the software menu 401 corresponding to the hard key 221 is displayed on the display 220.

### Procedure of Software Menu Execution Operation in IWB

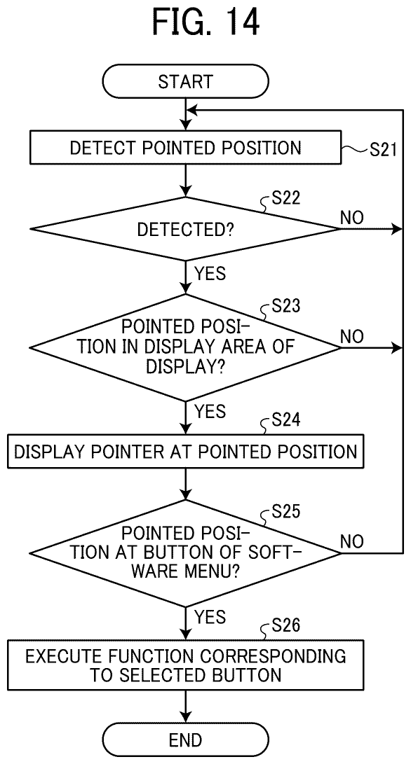

FIG. 14 is a flowchart illustrating an example of the procedure of a software menu execution operation in the IWB according to the first embodiment. With reference to FIG. 14, the procedure of the software menu execution operation in the IWB 10 according to the present embodiment will be described. Note that the description will be given on the assumption that the software menu 401 corresponding to the hard key 221 is already displayed on the display 220.

In step S21, the image reception unit 101 receives, via the external device connection I/F 206, captured images (i.e., the left captured image and the right captured image) obtained by the cameras 20a and 20b. The pointed position detection unit 103 then detects the pointed position pointed to by the pointing object 30 such as a user's finger, by using the right captured image and the left captured image received by the image reception unit 101. The process then proceeds to step S22.

In step S22, when the pointed position is detected by the pointed position detection unit 103 (step S22: Yes), the process proceeds to step S23. When the pointed position is not detected (step S22: No), the process returns to step S21.

In step S23, with reference to the area definition table stored in the storage unit 106, the determination unit 104 determines whether the pointed position pointed to by the pointing object 30 and detected by the pointed position detection unit 103 is in the display area of the display 220 defined by the area definition table. When the pointed position is in the display area of the display 220 (step S23: Yes), the process proceeds to step S24. When the pointed position is outside the display area of the display 220 (step S23: No), the process proceeds to step S21.

In step S24, the display control unit 105 causes the pointer P to be displayed at the pointed position on the display 220 to make the pointed position visible. The process then proceeds to step S25.

In step S25, the determination unit 104 determines whether the pointed position pointed to by the pointing object 30 and detected by the pointed position detection unit 103 is at a button of the software menu 401 displayed on the display 220. When the pointed position is at the button (step S25: Yes), the process proceeds to step S26. When the pointed position is not at the button (step S25: No), the process returns to step S21.

In step S26, when the pointed position is determined to be at the button of the software menu 401, the IWB 10 regards the button of the software menu 401 as being pressed (selected) and executes a function of a button of the hard key 221 corresponding to the button of the software menu 401. Note that the content of the function executed in response to deemed pressing (selection) of the button located at the pointed position is not limited. The software menu execution operation then ends.

Such a procedure allows the function corresponding to each button in the displayed software menu 401 to be executed.

### Procedure of Software Menu Hide Operation in IWB

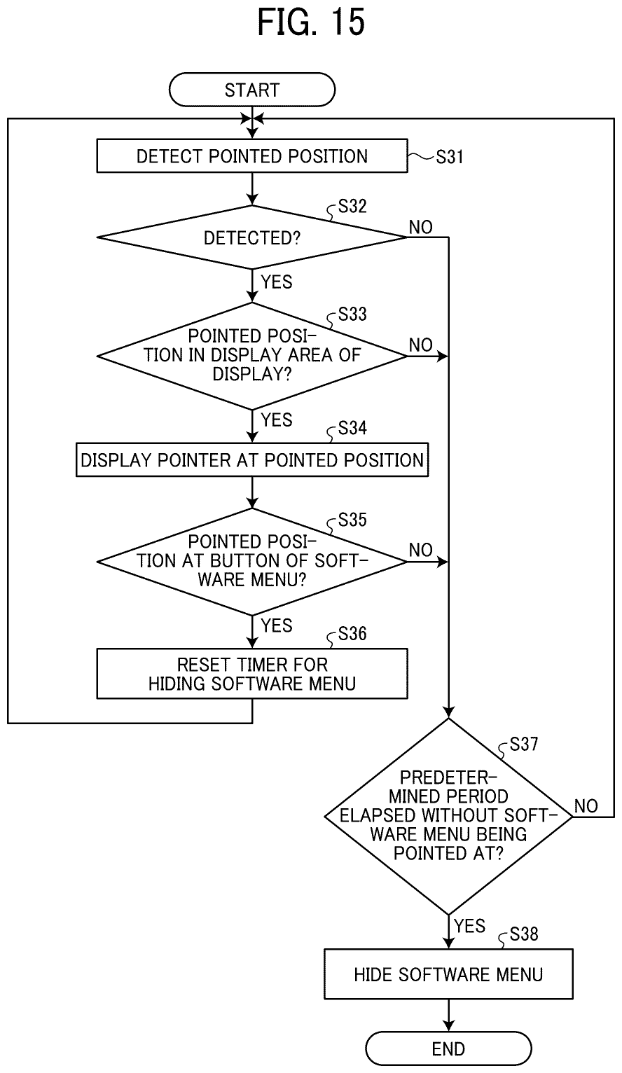

FIG. 15 is a flowchart illustrating an example of the procedure of a software menu hide operation in the IWB according to the first embodiment. With reference to FIG. 15, the procedure of the software menu hide operation in the IWB 10 according to the present embodiment will be described. Note that the description will be given on the assumption that the software menu 401 corresponding to the hard key 221 is already displayed on the display 220. The display control unit 105 starts measurement by a timer that indicates an elapsed time since the software menu 401 is displayed.

In step S31, the image reception unit 101 receives, via the external device connection I/F 206, captured images (i.e., the left captured image and the right captured image) obtained by the cameras 20a and 20b. The pointed position detection unit 103 then detects the pointed position pointed to by the pointing object 30 such as a user's finger, by using the right captured image and the left captured image received by the image reception unit 101. The process then proceeds to step S32.

In step S32, when the pointed position is detected by the pointed position detection unit 103 (step S32: Yes), the process proceeds to step S33. When the pointed position is not detected (step S32: No), the process returns to step S37.

In step S33, with reference to the area definition table stored in the storage unit 106, the determination unit 104 determines whether the pointed position pointed to by the pointing object 30 and detected by the pointed position detection unit 103 is in the display area of the display 220 defined by the area definition table. When the pointed position is in the display area of the display 220 (step S33: Yes), the process proceeds to step S34. When the pointed position is outside the display area of the display 220 (step S33: No), the process proceeds to step S37.

In step S34, the display control unit 105 causes the pointer P to be displayed at the pointed position on the display 220 to make the pointed position visible. The process then proceeds to step S35.

In step S35, the determination unit 104 determines whether the pointed position pointed to by the pointing object 30 and detected by the pointed position detection unit 103 is at a button of the software menu 401 displayed on the display 220. When the pointed position is at the button (step S35: Yes), the process proceeds to step S36. When the pointed position is not at the button (step S35: No), the process proceeds to step S37.

In step S36, the display control unit 105 resets the timer that started the measurement when the software menu 401 was displayed. The process then returns to step S31.

In step S37, the display control unit 105 determines whether the timer that started the measurement when the software menu 401 was displayed (i.e., the time that has elapsed without the button of the software menu 401 being pointed at) indicates that a predetermined period (e.g., 10 seconds) has elapsed. When the predetermined period has elapsed (step S37: Yes), the process proceeds to step S38. When the predetermined period has not elapsed (step

S37: No), the process returns to step S31.

In step S38, the display control unit 105 hides the software menu 401. The software menu hide operation then ends.

This allows the displayed software menu 401 to be automatically hidden when the state in which no operation is performed on the displayed software menu 401 continues for the predetermined period.

As described above, in the IWB 10 according to the present embodiment, the image reception unit 101 receives captured images of the pointing object 30 from the cameras 20a and 20b that capture images of the pointing object 30. The pointed position detection unit 103 detects a pointed position pointed to by the pointing object 30 from the captured images received by the image reception unit 101. The determination unit 104 determines whether the pointed position detected by the pointed position detection unit 103 is in an area of the hard key 221 installed on the IWB 10. Based on a condition that at least the determination unit 104 determines that the pointed position is in the area of the hard key 221, the IWB 10 executes a function corresponding to the button of the hard key 221. Specifically, when the determination unit 104 determines that the pointed position is in the area of the hard key 221, the display control unit 105 causes the software menu 401 for executing the function of the button of the hard key 221 to be displayed on the display 220 of the IWB 10. The determination unit 104 determines whether the pointed position is at a button of the software menu 401. When the determination unit 104 determines that the pointed position is at the button of the software menu 401, the IWB 10 executes a function of a button of the hard key 221 corresponding to the button of the software menu 401. This allows the function of the hard key 221 of the IWB 10 to be operated from a remote place.

### Second Embodiment

An IWB according to a second embodiment will be described mainly about differences from the IWB 10 according to the first embodiment. The present embodiment describes an operation to be performed in response to the pointed position being still for a predetermined period or longer. The general arrangement of the information processing system and the hardware configuration of the IWB according to the present embodiment are substantially the same as the configurations described in the first embodiment.

### Configuration and Operation of Functional Blocks of IWB

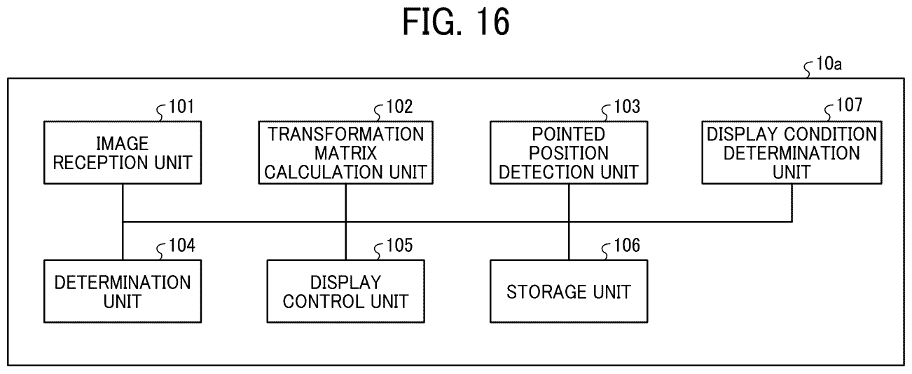

FIG. 16 is a diagram illustrating an example of a configuration of functional blocks of the IWB according to the second embodiment. With reference to FIG. 16, the configuration and the operation of the functional blocks of an IWB 10a according to the present embodiment will be described.

As illustrated in FIG. 16, the IWB 10a (an example of an electronic device, an example of an information processing apparatus) includes an image reception unit 101 (reception unit), a transformation matrix calculation unit 102, a pointed position detection unit 103 (detection unit), a determination unit 104 (first determination unit), a display control unit 105, a storage unit 106, and a display condition determination unit 107 (second determination unit). Note that operations of the image reception unit 101, the transformation matrix calculation unit 102, the pointed position detection unit 103, the determination unit 104, the display control unit 105, and the storage unit 106 are substantially the same as those in the first embodiment described above.

The display condition determination unit 107 is a functional unit that determines whether a condition for displaying the software menu 401 is met when the pointed position pointed to by the pointing object 30 and detected by the pointed position detection unit 103 is in the area of the hard key 221. When the condition is met, the display control unit 105 causes the software menu 401 to be displayed in the display area of the display 220 near the hard key 221. On the other hand, when the condition is not met, the display control unit 105 does not cause the software menu 401 to be displayed on the display 220.

The image reception unit 101, the transformation matrix calculation unit 102, the pointed position detection unit 103, the determination unit 104, the display control unit 105, and the display condition determination unit 107 described above are implemented by the CPU 201 illustrated in FIG. 2 executing a program. Note that at least part of the image reception unit 101, the transformation matrix calculation unit 102, the pointed position detection unit 103, the determination unit 104, the display control unit 105, and the display condition determination unit 107 may be implemented by hardware circuitry such as an FPGA or an ASIC.

All of the image reception unit 101, the transformation matrix calculation unit 102, the pointed position detection unit 103, the determination unit 104, the display control unit 105, the storage unit 106, and the display condition determination unit 107 are implemented in the IWB 10a. However, the configuration is not limited to this one, and at least one of these units may be implemented in another information processing apparatus.

The functional units of the IWB 10a illustrated in FIG. 16 are a conceptual illustration of the functions, and are not limited to such a configuration. That is, the functional units of the IWB 10a are not necessarily configured as software modules that are explicit as the blocks illustrated in FIG. 16. The functions of the functional units may be implemented as a whole as a result of execution of the program in the IWB 10a. For example, a plurality of functional units illustrated as the independent functional units in the IWB 10a in FIG. 16 may be configured as a single functional unit. Conversely, the function of one of the functional units of the IWB 10a illustrated in FIG. 16 may be divided and configured as a plurality of functional units.

### Procedure of Software Menu Display Operation in IWB

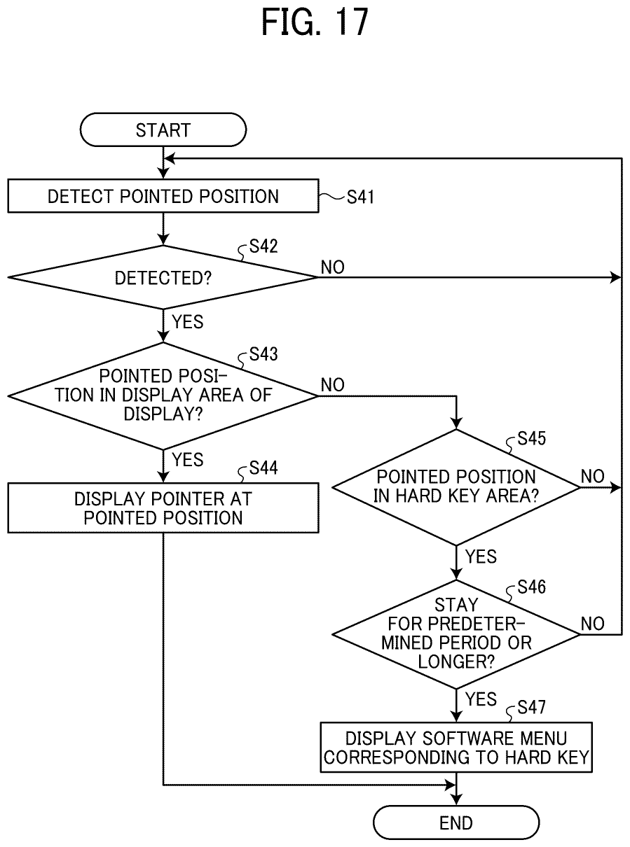

FIG. 17 is a flowchart illustrating an example of the procedure of a software menu display operation in the IWB according to the second embodiment. With reference to FIG. 17, the procedure of the software menu display operation in the IWB 10a according to the present embodiment will be described.

Processing of steps S41 to S45 is substantially the same as the processing of steps S11 to S15 illustrated in FIG. 13 described above, respectively. When the pointed position is in the area of the hard key 221 (step S45: Yes), the process proceeds to step S46. When the pointed position is outside the area of the hard key 221 (step S45: No), the process returns to step S41.

In step S46, the display condition determination unit 107 of the IWB 10a determines whether the pointed position pointed to by the pointing object 30 and detected by the pointed position detection unit 103 is in the area of the hard key 221 for a predetermined period (e.g., 2 seconds) or longer. When the pointed position is in the area of the hard key 221 for the predetermined period or longer (step S46: Yes), the process proceeds to step S47. When the pointed position is not in the area of the hard key 221 for the predetermined period or longer (step S46: No), the process returns to step S41 and the software menu 401 is not displayed.

In step S47, the display control unit 105 causes the software menu 401 to be displayed in the display area of the display 220 near the hard key 221. The software menu display operation then ends.

### Procedure of Software Menu Execution Operation in IWB

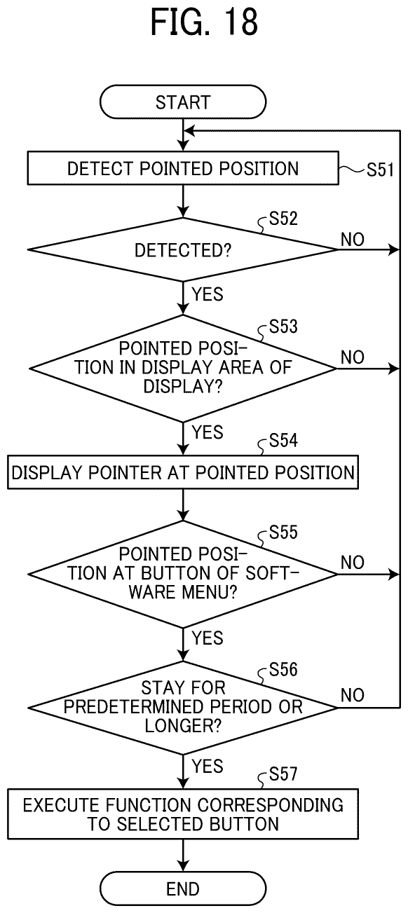

FIG. 18 is a flowchart illustrating an example of the procedure of a software menu execution operation in the IWB according to the second embodiment. With reference to FIG. 18, the procedure of the software menu execution operation in the IWB 10a according to the present embodiment will be described. Note that the description will be given on the assumption that the software menu 401 corresponding to the hard key 221 is already displayed on the display 220.

Processing of steps S51 to S55 is substantially the same as the processing of steps S21 to S25 illustrated in FIG. 14 described above, respectively. When the pointed position is at the button of the software menu 401 (step S55: Yes), the process proceeds to step S56. When the pointed position is not at the button (step S55: No), the process returns to step S51.

In step S56, the display condition determination unit 107 of the IWB 10a determines whether the pointed position pointed to by the pointing object 30 and detected by the pointed position detection unit 103 is at the button of the software menu 401 for a predetermined period (e.g., 2 seconds) or longer. When the pointed position is at the button of the software menu 401 for the predetermined period or longer (step S56: Yes), the process proceeds to step S57. When the pointed position is not at the button of the software menu 401 for the predetermined period or longer (step S56: No), the process returns to step S51 and the function corresponding to the button is not executed.

In step S57, when the display condition determination unit 107 determines that the pointed position is at the button of the software menu 401 for the predetermined period or longer, the IWB 10a regards the button of the software menu 401 as being pressed (selected) and executes the function of a button of the hard key 221 corresponding to the button of the software menu 401. Note that the content of the function executed in response to deemed pressing (selection) of the button located at the pointed position is not limited. The software menu execution operation then ends.

As described above, in the IWB 10a according to the present embodiment, the display condition determination unit 107 determines whether the pointed position is in the area of the hard key 221 for a predetermined period or longer. The display control unit 105 causes the software menu 401 to be displayed on the display 220 when the display condition determination unit 107 determines that the pointed position is in the area of the hard key 221 for the predetermined period or longer. The display condition determination unit 107 determines whether the pointed position is at a button of the software menu 401 for a predetermined period or longer. The IWB 10a executes the function of a button of the hard key 221 corresponding to the button of the software menu 401 when the display condition determination unit 107 determines that the pointed position is at the button of the software menu 401 for the predetermined period or longer. This provides the same advantageous effects as those of the first embodiment described above and enables unintended power off of the display 220 and unintended display of the software menu 401 to be avoided.

### Third Embodiment

An IWB according to a third embodiment will be described mainly about differences from the IWB 10 according to the first embodiment. The present embodiment describes an operation to be performed in response to a specific gesture.

### Hardware Configuration of IWB

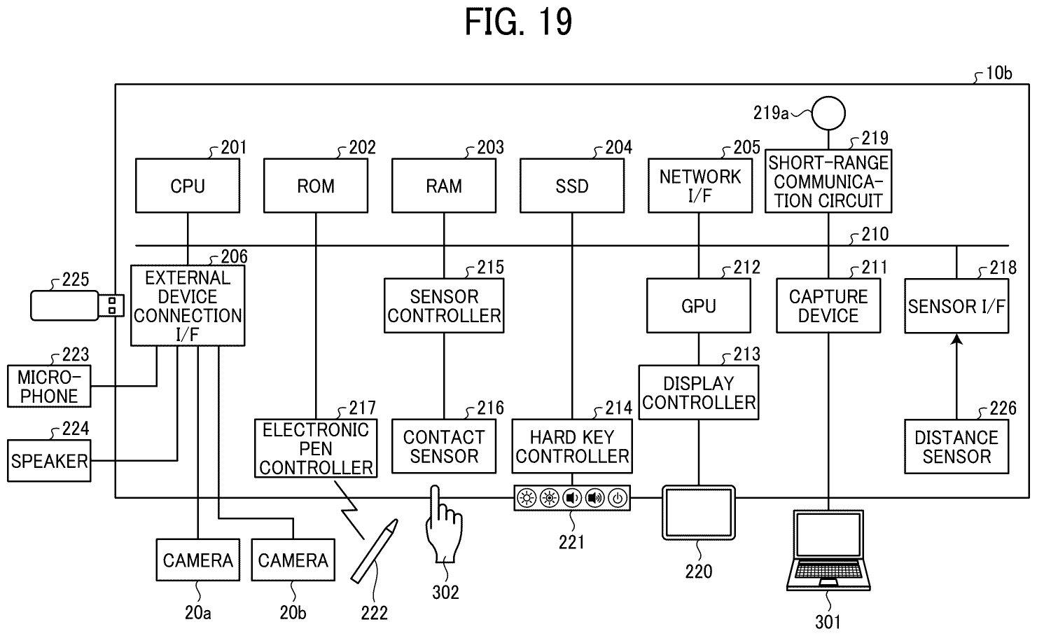

FIG. 19 is a diagram illustrating an example of a hardware configuration of the IWB according to the third embodiment. The hardware configuration of an IWB 10b according to the present embodiment will be described with reference to FIG. 19.

As illustrated in FIG. 19, the IWB 10b (an example of an electronic device, an example of an information processing apparatus) according to the present embodiment includes a CPU 201, a ROM 202, a RAM 203, an SSD 204, a network I/F 205, an external device connection I/F 206, a capture device 211, a GPU 212, a display controller 213, a hard key controller 214, a sensor controller 215, a contact sensor 216, an electronic pen controller 217, a display 220, a hard key 221, a sensor I/F 218, and a distance sensor 226. Operations of the devices other than the sensor I/F 218 and the distance sensor 226 among the aforementioned devices are substantially the same as those of the first embodiment described above.

The sensor I/F 218 is an interface circuit to receive a distance image measured by the distance sensor 226.

The distance sensor 226 is a sensor that measures a distance from the IWB 10b to a target such as the pointing object 30 of the user. Specifically, the distance sensor 226 has a structure in which pairs of an infrared laser diode and a light-receiving element are arranged in a matrix of 500×500. The distance sensor 226 measures a distance to the target, based on a time from emission of light from the infrared laser diode to reception of reflected light of the emitted light, and outputs the distance as a distance image. The distance sensor 226 is installed, for example, at an upper or lower part of the IWB 10b.

### Configuration and Operation of Functional Blocks of IWB

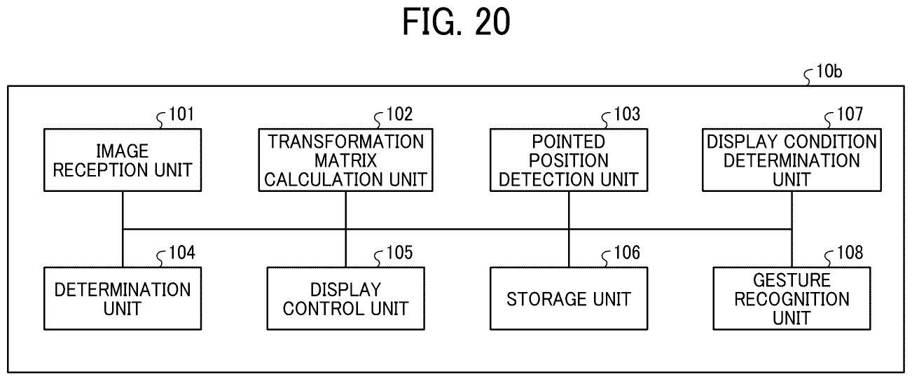

FIG. 20 is a diagram illustrating an example of a configuration of functional blocks of the IWB according to the third embodiment. With reference to FIG. 20, the configuration and the operation of functional blocks of the IWB 10b according to the present embodiment will be described.

As illustrated in FIG. 20, the IWB 10b includes an image reception unit 101 (reception unit), a transformation matrix calculation unit 102, a pointed position detection unit 103 (detection unit), a determination unit 104 (first determination unit), a display control unit 105, a storage unit 106, a display condition determination unit 107 (second determination unit), and a gesture recognition unit 108 (recognition unit). Note that operations of the image reception unit 101, the transformation matrix calculation unit 102, the pointed position detection unit 103, the determination unit 104, the display control unit 105, the storage unit 106, and the display condition determination unit 107 are substantially the same as those in the second embodiment described above.

The gesture recognition unit 108 is a functional unit that acquires, via the sensor I/F 218, data of the distance image measured by the distance sensor 226, and recognizes a gesture of the pointing object 30 from the distance image. Specifically, the gesture recognition unit 108 detects a moving object from the acquired distance image, and compares shape data and color data of the object with pre-stored shape data and color data of a hand to recognize a gesture of the object which may be a hand with one pointing finger or two pointing fingers. The recognition processing may be performed using machine learning based on many shape data items and color data items of hands, for example.

The image reception unit 101, the transformation matrix calculation unit 102, the pointed position detection unit 103, the determination unit 104, the display control unit 105, the display condition determination unit 107, and the gesture recognition unit 108 described above are implemented by the CPU 201 illustrated in FIG. 2 executing a program. Note that at least part of the image reception unit 101, the transformation matrix calculation unit 102, the pointed position detection unit 103, the determination unit 104, the display control unit 105, the display condition determination unit 107, and the gesture recognition unit 108 may be implemented by hardware circuitry such as an FPGA or an ASIC.

All of the image reception unit 101, the transformation matrix calculation unit 102, the pointed position detection unit 103, the determination unit 104, the display control unit 105, the storage unit 106, the display condition determination unit 107, and the gesture recognition unit 108 are implemented in the IWB 10b. However, the configuration is not limited to this one, and at least one of these units may be implemented in another information processing apparatus.

The functional units of the IWB 10b illustrated in FIG. 20 are a conceptual illustration of the functions, and are not limited to such a configuration. That is, the functional units of the IWB 10b are not necessarily configured as software modules that are explicit as the blocks illustrated in FIG. 20. The functions of the functional units may be implemented as a whole as a result of execution of the program in the IWB 10b. For example, a plurality of functional units illustrated as the independent functional units in the IWB 10b in FIG. 20 may be configured as a single functional unit. Conversely, the function of one of the functional units of the IWB 10b illustrated in FIG. 20 may be divided and configured as a plurality of functional units.

### Procedure of Software Menu Display Operation in IWB

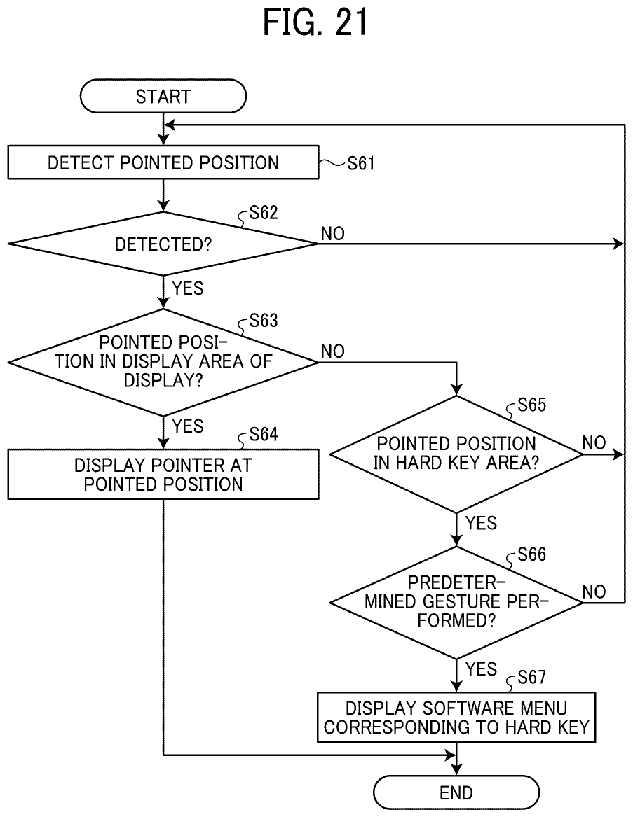

FIG. 21 is a flowchart illustrating an example of the procedure of a software menu display operation in the IWB according to the third embodiment. With reference to FIG. 21, the procedure of the software menu display operation in the IWB 10b according to the present embodiment will be described.

Processing of steps S61 to S65 is substantially the same as the processing of steps S11 to S15 illustrated in FIG. 13 described above, respectively. When the pointed position is in the area of the hard key 221 (step S65: Yes), the process proceeds to step S66. When the pointed position is outside the area (step S65: No), the process returns to step S61.

In step S66, the gesture recognition unit 108 of the IWB 10b acquires, via the sensor I/F 218, data of the distance image measured by the distance sensor 226, and recognizes a gesture of the pointing object 30 from the distance image. The display condition determination unit 107 determines whether the gesture recognized by the gesture recognition unit 108 is a predetermined gesture. When the recognized gesture is the predetermined gesture (step S66: Yes), the process proceeds to step S67. When the recognized gesture is not the predetermined gesture (step S66: No), the process returns to step S61 and the software menu 401 is not displayed. Note that the predetermined gesture is a gesture that is determined in advance for displaying the software menu 401. For example, the predetermined gesture is a gesture of pointing a position in the area of the hard key 221, immediately stopping the pointing (e.g., within 1 second), and pointing again (e.g., gesture of moving the fingertip upward once and then pointing the position again similar to tapping a button) or a gesture of changing the number of pointing fingers from one to two.

In step S67, the display control unit 105 causes the software menu 401 to be displayed in the display area of the display 220 near the hard key 221. The software menu display operation then ends.

### Procedure of Software Menu Execution Operation in IWB

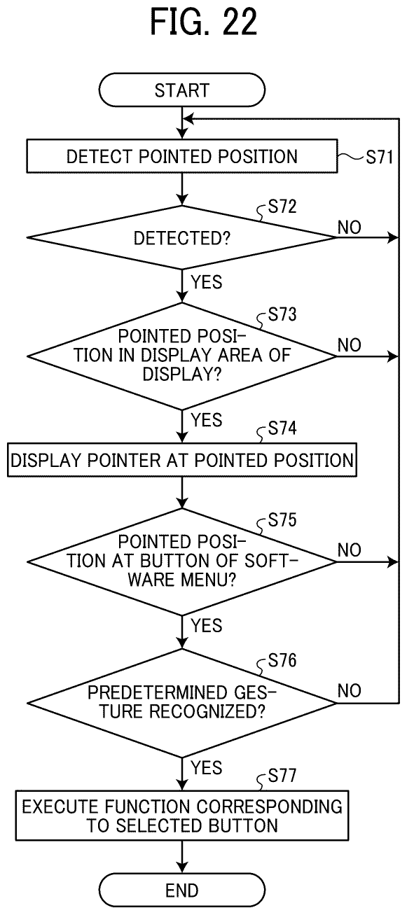

FIG. 22 is a flowchart illustrating an example of the procedure of a software menu execution operation in the IWB according to the third embodiment. With reference to FIG. 22, the procedure of the software menu execution operation in the IWB 10b according to the present embodiment will be described. Note that the description will be given on the assumption that the software menu 401 corresponding to the hard key 221 is already displayed on the display 220.

Processing of steps S71 to S75 is substantially the same as the processing of steps S21 to S25 illustrated in FIG. 14 described above, respectively. When the pointed position is at the button of the software menu 401 (step S75: Yes), the process proceeds to step S76. When the pointed position is not at the button (step S75: No), the process returns to step S71.

In step S76, the gesture recognition unit 108 of the IWB 10b acquires, via the sensor I/F 218, data of the distance image measured by the distance sensor 226, and recognizes a gesture of the pointing object 30 from the distance image. The display condition determination unit 107 determines whether the gesture recognized by the gesture recognition unit 108 is a predetermined gesture. When the recognized gesture is the predetermined gesture (step S76: Yes), the process proceeds to step S77. When the recognized gesture is not the predetermined gesture (step S76: No), the process returns to step S71 and the function corresponding to the button of the software menu 401 is not executed. Note that the predetermined gesture is a gesture determined in advance for executing the function of the button of the software menu 401.

In step S77, when the display condition determination unit 107 determines that the gesture recognized by the gesture recognition unit 108 is the predetermined gesture, the IWB 10b regards the button of the software menu 401 at the pointed position as being pressed (selected) and executes the function of a button of the hard key 221 corresponding to the button of the software menu 401. Note that the content of the function executed in response to deemed pressing (selection) of the button located at the pointed position is not limited. The software menu execution operation then ends.

As described above, in the IWB 10b according to the present embodiment, the gesture recognition unit 108 recognizes a gesture of the pointing object 30. The display condition determination unit 107 determines whether the gesture recognized by the gesture recognition unit 108 is a predetermined gesture. The display control unit 105 causes the software menu 401 to be displayed on the display 220 when the display condition determination unit 107 determines that the gesture recognized by the gesture recognition unit 108 is the predetermined gesture. The display condition determination unit 107 determines whether the gesture recognized by the gesture recognition unit 108 is a predetermined gesture. The display control unit 105 executes the function of a button of the hard key 221 corresponding to the button of the software menu 401 corresponding to the pointed position determined to be at the button of the software menu 401 by the determination unit 104 when the display condition determination unit 107 determines that the gesture recognized by the gesture recognition unit 108 is the predetermined gesture. This provides the same advantageous effects as those of the first embodiment described above, enables unintended power off of the display 220 and unintended display of the software menu 401 to be avoided, and implements a reduced troublesomeness related to a waiting time.

### Fourth Embodiment

An IWB according to a fourth embodiment will be described mainly about differences from the IWB 10 according to the first embodiment. In the present embodiment, the description will be given of an operation of directly executing a function corresponding to a hard key located at a pointed position instead of displaying a software menu. The general arrangement of the information processing system and the hardware configuration and the functional block configuration of the IWB according to the present embodiment are substantially the same as the configurations described in the first embodiment.

### Procedure of Hard Key Function Execution Operation in IWB

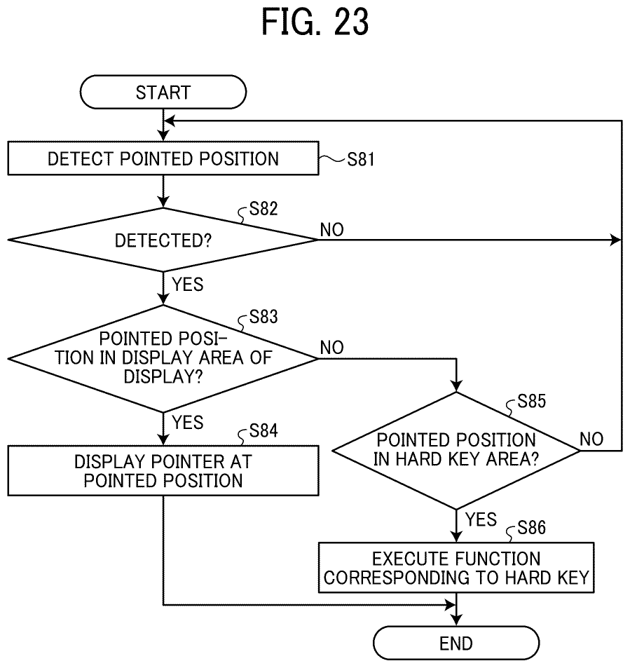

FIG. 23 is a flowchart illustrating an example of the procedure of a hard key function execution operation in the IWB according to the fourth embodiment. With reference to FIG. 23, the procedure of the hard key function execution operation in the IWB 10 according to the present embodiment will be described.

Processing of steps S81 to S85 is substantially the same as the processing of steps S11 to S15 illustrated in FIG. 13 described above, respectively. When the pointed position is in the area of the hard key 221 (step S85: Yes), the process proceeds to step S86. When the pointed position is outside the area (step S85: No), the process returns to step S81.

In step S86, the IWB 10 regards the button of the hard key 221 located at the pointed position as being pressed (selected) and executes a function corresponding to the button. Note that the function refers to a function to be executed in response to pressing of a button of the hard key 221 such as a function of causing the IWB 10 to return from a standby state by powering on the display 220 that is in a power-off state, for example. The hard key function execution operation then ends.

As described above, the IWB 10 according to the present embodiment executes a function corresponding to a button of the hard key 221 at the pointed position when the determination unit 104 determines that the pointed position is in the area of the hard key 221. This enables an immediate operation on the function of the hard key 221 of the IWB 10 from a remote place.

When at least one of the functional units of the IWB 10, 10a, or 10b is implemented as a result of execution of a program in the embodiments described above, the program is pre-installed on the ROM or the like and is provided. The program executed by the IWB 10, 10a, or 10b in the embodiments described above may be stored as a file in an installable or executable format on a computer-readable recording medium such as a compact disc read-only memory (CD-ROM), a flexible disk (FD), a compact disc recordable (CD-R), or a digital versatile disc (DVD) and be provided. The program executed by the IWB 10, 10a, or 10b in the embodiments described above may be stored on a computer connected to a network such as the Internet and may be downloaded via the network to be provided to the IWB 10, 10a, or 10b. The program executed by the IWB 10, 10a, or 10b in the embodiments described above may be provided or distributed via a network such as the Internet. The program executed by the IWB 10, 10a, or 10b in the embodiments described above has a module configuration including at least one of the functional units described above. The CPU 201 that is actual hardware reads the program from the storage device (e.g., the ROM 202 or the SSD 204) described above and executes the program to load and generate each of the functional units described above in the main storage device (the RAM 203).

Aspects of the present disclosure are as follows.

According to Aspect 1, an information processing apparatus includes a reception unit, a detection unit, and a first determination unit. The reception unit receives a captured image of a pointing object, from an image-capturing device that captures an image of the pointing object. The detection unit detects a pointed position pointed to by the pointing object from the captured image received by the reception unit. The first determination unit determines whether the pointed position detected by the detection unit is in an area of a hardware key installed on an electronic device. The information processing apparatus executes a function corresponding to a button of the hardware key, based on a condition that at least the first determination unit determines that the pointed position is in the area of the hardware key.

According to Aspect 2, the information processing apparatus of Aspect 1 further includes a display control unit. The display control unit causes a software menu to be displayed on a display of the electronic device, in the case where the first determination unit determines that the pointed position is in the area of the hardware key. The software menu is a menu for executing the function corresponding to the button of the hardware key.

According to Aspect 3, the information processing apparatus of Aspect 2 further includes a second determination unit. The second determination unit determines whether the pointed position is in the area of the hardware key for a predetermined period or longer. The display control unit causes the software menu to be displayed on the display, in a case where the second determination unit determines that the pointed position is in the area of the hardware key for the predetermined period or longer.

According to Aspect 4, the information processing apparatus of Aspect 2 further includes a recognition unit and a second determination unit. The recognition unit recognizes a gesture of the pointing object. The second determination unit determines whether the gesture recognized by the recognition unit is a predetermined gesture. The display control unit causes the software menu to be displayed on the display, in a case where the second determination unit determines that the gesture recognized by the recognition unit is the predetermined gesture.

According to Aspect 5, in the information processing apparatus of Aspect 2, the first determination unit determines whether the pointed position is at a button of the software menu. The information processing apparatus executes a function of a button of the hardware key corresponding to the button of the software menu, in a case where the first determination unit determines that the pointed position is at the button of the software menu.

According to Aspect 6, the information processing apparatus of Aspect 5 further includes a second determination unit. The second determination unit determines whether the pointed position is at the button of the software menu for a predetermined period or longer. The information processing apparatus executes the function of the button of the hardware key corresponding to the button of the software menu, in a case where the second determination unit determines that the pointed position is at the button of the software menu for the predetermined period or longer.

According to Aspect 7, the information processing apparatus of Aspect 5 further includes a recognition unit and a second determination unit. The recognition unit recognizes a gesture of the pointing object. The second determination unit determines whether the gesture recognized by the recognition unit is a predetermined gesture. The display control unit executes the function of the button of the hardware key corresponding to the button of the software menu, the button of the software menu corresponding to the pointed position that is determined to be at the button of the software menu by the first determination unit, in a case where the second determination unit determines that the gesture recognized by the recognition unit is the predetermined gesture.

According to Aspect 8, in the information processing apparatus of any one of Aspects 2 to 7, the display control unit hides the software menu in a case where a predetermined period has elapsed in a state where the button of the software menu is not pointed at.

According to Aspect 9, the information processing apparatus of Aspect 1 executes the function corresponding to the button of the hardware key at the pointed position, in a case where the first determination unit determines that the pointed position is in the area of the hardware key.

According to Aspect 10, an information processing method includes: receiving a captured image of a pointing object, from an image-capturing device that captures an image of the pointing object; detecting a pointed position pointed to by the pointing object from the received captured image; determining whether the detected pointed position is in an area of a hardware key installed on an electronic device; and executing a function corresponding to a button of the hardware key, based on a condition that at least it is determined that the pointed position is in the area of the hardware key at least in the determining.

According to Aspect 11, a program causes a computer to execute: receiving a captured image of a pointing object, from an image-capturing device that captures an image of the pointing object; detecting a pointed position pointed to by the pointing object from the received captured image; determining whether the detected pointed position is in an area of a hardware key installed on an electronic device; and executing a function corresponding to a button of the hardware key, based on a condition that at least it is determined that the pointed position is in the area of the hardware key at least in the determining.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing apparatus comprising circuitry configured to:
receive a captured image of a pointing object, from an image-capturing device that captures an image of the pointing object;
detect a pointed position pointed to by the pointing object from the received captured image;
determine whether the detected pointed position is in an area of a hardware key installed on an electronic device; and
execute a function corresponding to a button of the hardware key, based on a determination that the pointed position is in the area of the hardware key.

2. The information processing apparatus according to claim 1, wherein the circuitry is configured to cause a software menu to be displayed on a display of the electronic device, based on the determination that the pointed position is in the area of the hardware key, the software menu being a menu for executing the function corresponding to the button of the hardware key.

3. The information processing apparatus according to claim 2, wherein the circuitry is further configured to:
determine whether the pointed position is in the area of the hardware key for a predetermined period or longer; and
cause the software menu to be displayed on the display, based on a determination that the pointed position is in the area of the hardware key for the predetermined period or longer.

4. The information processing apparatus according to claim 2, wherein the circuitry is configured to:
recognize a gesture of the pointing object;
determine whether the recognized gesture is a predetermined gesture; and
cause the software menu to be displayed on the display, based on a determination that the recognized gesture is the predetermined gesture.

5. The information processing apparatus according to claim 2, wherein the circuitry is configured to:
determine whether the pointed position is at a button of the software menu; and
execute a function of a button of the hardware key corresponding to the button of the software menu, based on a determination that the pointed position is at the button of the software menu.

6. The information processing apparatus according to claim 5, wherein the circuitry is configured to:
determine whether the pointed position is at the button of the software menu for a predetermined period or longer; and
execute the function of the button of the hardware key corresponding to the button of the software menu, based on a determination that the pointed position is at the button of the software menu for the predetermined period or longer.

7. The information processing apparatus according to claim 5, wherein the circuitry is further configured to:
recognize a gesture of the pointing object;
determine whether the recognized gesture is a predetermined gesture; and
execute the function of the button of the hardware key corresponding to the button of the software menu, the button of the software menu corresponding to the pointed position that is determined to be at the button of the software menu, based on a determination that the recognized gesture is the predetermined gesture.

8. The information processing apparatus according to claim 5, wherein the circuitry is configured to hide the software menu in a case where a predetermined period has elapsed in a state where the button of the software menu is not pointed at.

9. The information processing apparatus according to claim 1, wherein the circuitry is configured to execute the function corresponding to the button of the hardware key at the pointed position, based on a determination that the pointed position is in the area of the hardware key.

10. An information processing method comprising:
receiving a captured image of a pointing object, from an image-capturing device that captures an image of the pointing object;
detecting a pointed position pointed to by the pointing object from the received captured image;
determining whether the detected pointed position is in an area of a hardware key installed on an electronic device; and
executing a function corresponding to a button of the hardware key, based on a determination that the pointed position is in the area of the hardware key.

11. A non-transitory recording medium storing a plurality of instructions which, when executed by one or more processors, causes the one or more processors to perform an information processing method comprising:
receiving a captured image of a pointing object, from an image-capturing device that captures an image of the pointing object;
detecting a pointed position pointed to by the pointing object from the received captured image;
determining whether the detected pointed position is in an area of a hardware key installed on an electronic device; and
executing a function corresponding to a button of the hardware key, based on a determination that the pointed position is in the area of the hardware key.
